(19) United States
(12) Patent Application Publication
(10) Pub. No.: US 2006/0028543 A1
(43) Pub. Date: Feb. 9, 2006

(54) Method and apparatus for controlling convergence distance for observation of 3D image

(75) Inventors: Jun-il Sohn, Yongin-si (KR); Soo-hyun Bae, Seoul (KR); Joon-kee Cho, Yongin-si (KR); Sang-goog Lee, Anyang-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/194,696

(22) Filed: Aug. 2, 2005

(30) Foreign Application Priority Data
Aug. 3, 2004 (KR) 10-2004-0061093

(51) Int. Cl. H04N 13/00; H04N 15/00

(52) U.S. Cl. 348/42

(57) ABSTRACT

A method and an apparatus for controlling a convergence distance for observation of a 3-D image are provided. The apparatus includes an object image storage, a guide image storage, an image synthesizer, and a controller. The object image storage stores object image data generated by photographing 3-dimensionally an object positioned at an object image point. The guide image storage stores guide image data generated by sequentially moving back and forth of the object image point and photographing 3-dimensionally a guide object. The image synthesizer receives the object image data and the guide image data to generate a synthesized image. The controller controls to sequentially output the guide image data and if a photographing distance of the guide image data coincides with an object image point, controls to stop the outputting of the guide image data so that a convergence distance of an observer may coincide with the object image point.

### BACKGROUND OF THE INVENTION

This application claims the priority of Korean Patent Application No. 10-2004-0061093, filed on Aug. 3, 2004, in the Korean Intellectual Property Office, the disclosure of which is incorporated herein in its entirety by reference.

1. Field of the Invention

The present invention relates to a method and an apparatus for controlling a convergence distance for observation of a 3-dimensional (3-D) image, and more particularly, to a method and an apparatus for easily realizing a cubic effect of a 3-D image without a separate head/eyeball movement detector for detecting a head/eyeball movement so as to ascertain a convergence distance of an observer, and without the inconvenience of wearing a separate display apparatus. Further, some methods and apparatus consistent with the invention reduce eyesight fatigue caused by inducing eyeball movement of an observer when observing an object image for a long time.

2. Description of the Related Art

A human being has eyeballs on both the left and right sides. Since the positions of the eyeballs on the two sides are different from each other, an image focused on a retina of an eyeball on the right and an image focused on a retina of an eyeball on the left are different. Further, the amount of difference in the images focused on the two eyeballs varies with the distance from the observer to the object. That is, when an object is close to the observer, the difference between images focused on the two eyeballs is large. On the contrary, when an object is far from the observer, the difference between images focused on the two eyeballs begins to disappear. Thus, information regarding a relevant distance can be recovered using a difference between images focused on the two eyeballs, whereby a cubic effect is realized.

With application of such a principle, it is possible to realize a 3-D image by making different images appear at the two eyeballs, respectively. Such a method is currently being used in realizing a 3-D movie or a virtual reality.

Despite an excellent sense of reality provided by a 3-D image, such an apparatus is not widely distributed because there is a problem that eyes are easily fatigued when seeing a 3-D image. The reason why eyes are easily fatigued is that a related art 3-D image display method provides images for both sides set in advance to both eyeballs, thus an observer should adjust a convergence distance to a given image.

However, in everyday life a person moves his or her face or eyes to freely see a desired place and the adjusting the convergence distance to the image set in advance becomes a very unnatural circumstance, giving a great burden to the eyes.

As described above, in a related art method and apparatus for displaying a 3-D image, a convergence distance is given in one way for images on both sides representing a 3-D image, thus an observer should force his or her eyeballs to move so as to follow the given convergence distance.

FIG. 1 is a view illustrating a construction of an apparatus for displaying a virtual reality 3-D image according to one embodiment of the related art. The apparatus of FIG. 1 is disclosed in a Korean Patent Registration No. 380994, entitled “Three-dimensional display apparatus and method with gaze point feedback”.

The Korean Patent actively displays a stereo image that corresponds to a relevant convergence point on the basis of convergence point information extracted from a position of an observer's head (face) and an eyeball's movement. Thus, the restriction of adjusting a focal length by an observer is removed so that an observer can arbitrarily see a desired point in his field of view and arbitrarily change a convergence point. That is, the Korean Patent discloses a 3-D displaying apparatus and method for removing eye fatigue when seeing a 3-D image and providing a natural image, and a computer-readable recording medium on which a program for realizing the above method is recorded.

More careful examination of FIG. 1 shows that a related art virtual reality 3-D displaying apparatus includes: a 3-D model storage 110 for generating in advance and storing a 3-D model of an object existing in a virtual reality space that will be seen by a user; a head/eyeball movement detector 160 for extracting a position of a head (face) and an image of two eyeballs; a convergence direction and distance measurement unit 120 for extracting information regarding a current convergence point of a user using the head's position and the eyeball image delivered from the head/eyeball movement detector 160; an image generator 130 for generating a stereo image that corresponds to the current convergence point extracted from the convergence direction and distance measurement unit 120 on the basis of the 3-D model of the object stored in the 3-D model storage 110; a left-image display unit 140 for displaying a left image generated at the image generator 130; a right-image display unit 150 for displaying a right image generated at the image generator 130; and a stereo image display unit 160 for displaying the left and the right images from the left and the right-image display units 140 and 150 on an actual screen.

However, for ascertaining a current convergence point of a user through a head's position and an eyeball image of a user, the head/eyeball movement detector for detecting a head/eyeball movement is separately provided and a user should wear a separate display apparatus.

Further, since a current convergence point of a user should be ascertained in real time through the head's position and the eyeball image, the amount of data to process is increased, whereby a system is complicated.

In the meantime, since an eyeball should be fixed to a predetermined point so that a 3-D image may be observed effectively for a long time, an eyesight fatigue problem is generated.

### SUMMARY OF THE INVENTION

The present invention provides a method and an apparatus for controlling a convergence distance for observation of a 3-D image, in which a guide image sequentially moved, photographed, and played back and forth of a convergence distance of an observer by a convergence distance controller so that an observer can easily find a position point at which an object image is displayed by controlling a convergence distance using the guide image.

According to an aspect of the present invention, there is provided a convergence distance controller, which includes: an object image storage for storing object image data, which is data to show an observer and generated by photographing 3-dimensionally an object positioned at an object image point, which is a predetermined point in a space; a guide image storage for storing guide image data, which is data for guiding a convergence distance of the observer and generated by sequentially moving back and forth of the object image point and photographing 3-dimensionally a guide object; an image synthesizer for receiving the object image data and the guide image data to generate a synthesized image; and a controller for sequentially outputting the guide image data stored in the guide image storage and if a photographing distance of the guide image data agrees with an object image point, stopping the outputting of the guide image data to guide a convergence distance of an observer to coincide with the object image point.

The controller may control to sequentially output photographed guide image data when the guide object moves from a point at which the convergence distance controller is positioned to a point at which the observer is positioned by way of the object image point and to sequentially output photographed guide image data when the guide object moves from the observer point to the object image point and if a photographing distance of the guide image data coincides with the object image point, control to stop the outputting of the guide image data.

Further, the controller may control to sequentially output photographed guide image data when the guide object moves from a point at which the observer is positioned to a point at which the convergence distance controller is positioned and control to sequentially output photographed guide image data when the guide object moves from a point at which the convergence distance controller is positioned to an object image point, and if a photographing distance of the guide image data coincides with the object image point, control to stop the outputting of the guide image data.

According to another aspect of the present invention, there is provided a method for controlling a convergence distance in an apparatus for controlling a convergence distance, which includes: receiving object image data, which is data to show an observer and generated by photographing 3-dimensionally an object positioned at an object image point, which is a predetermined point in a space; receiving guide image data, which is data for guiding a convergence distance of the observer and generated by sequentially moving back and forth of the object image point and photographing 3-dimensionally a guide object; receiving the object image data and the guide image data to synthesize those data and output a synthesized image; and controlling the guide image data to be sequentially received and if a photographing distance of the guide image data agrees with an object image point, controlling to stop the receiving of the guide image data so that a convergence distance of an observer may coincide with the object image point.

The controlling of the guide image data may include: controlling to sequentially output photographed guide image data when the guide object moves from a point at which the convergence distance controller is positioned to a point at the observer is positioned by way of the object image point; controlling to sequentially output photographed guide image data when the guide object moves from the observer point to the object image point; and if a photographing distance of the guide image data coincides with the object image point, controlling to stop the outputting of the guide image data.

Alternatively, the controlling of the guide image data may include: controlling to sequentially output photographed guide image data when the guide object moves from a point at which the observer is positioned to a point at which the convergence distance controller is positioned; controlling to sequentially output photographed guide image data when the guide object moves from a point at which the convergence distance controller is positioned to an object image point; and if a photographing distance of the guide image data coincides with the object image point, controlling to stop the outputting of the guide image data.

Further, there is provided a computer-readable recording medium storing a program for executing the above-described method on a computer.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a related art 3-D image display apparatus;

FIG. 2 is a view illustrating a convergence distance using eyeballs and a convergence point;

FIG. 3 is a view illustrating an object image distance;

FIG. 4 is a view illustrating a guide image distance;

FIG. 5 is a view illustrating that object image data is obtained by photographing an object using two cameras;

FIG. 6 is a view illustrating that the object image data obtained in FIG. 5 is played and shown to an observer;

FIG. 7 is a view illustrating that guide image data is obtained by photographing a guide object using two cameras;

FIG. 8 is a view illustrating that the guide image data obtained in FIG. 7 is played and shown to an observer;

FIG. 9 is a block diagram of a convergence distance controller for observation of a 3-D image according to one embodiment of the present invention;

FIG. 10 is a flowchart of a method for controlling a convergence distance for observation of a 3-D image according to one embodiment of the present invention; and

FIGS. 11A to 11E are views illustrating detailed operations of a method for controlling a convergence distance for observation of a 3-D image according to one embodiment of the present invention.

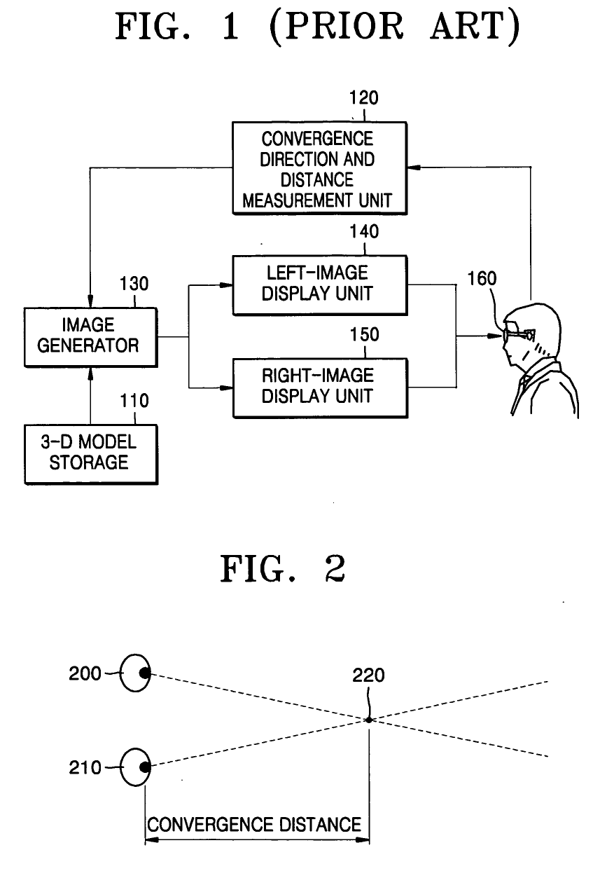

### DETAILED DESCRIPTION OF THE INVENTION

The present invention will now be described more fully with reference to the accompanying drawings, in which exemplary embodiments of the invention are shown.

FIG. 2 is a view illustrating a convergence distance using eyeballs and a convergence point.

Referring to FIG. 2, a convergence means that convergence lines from left and right eyeballs 200 and 210 are concentrated onto one point in the front. Here, a point at which both convergence lines meet is called a convergence point 220, and a distance between the eyeballs 200 and 210 on both sides and the convergence point 220 is called a convergence distance.

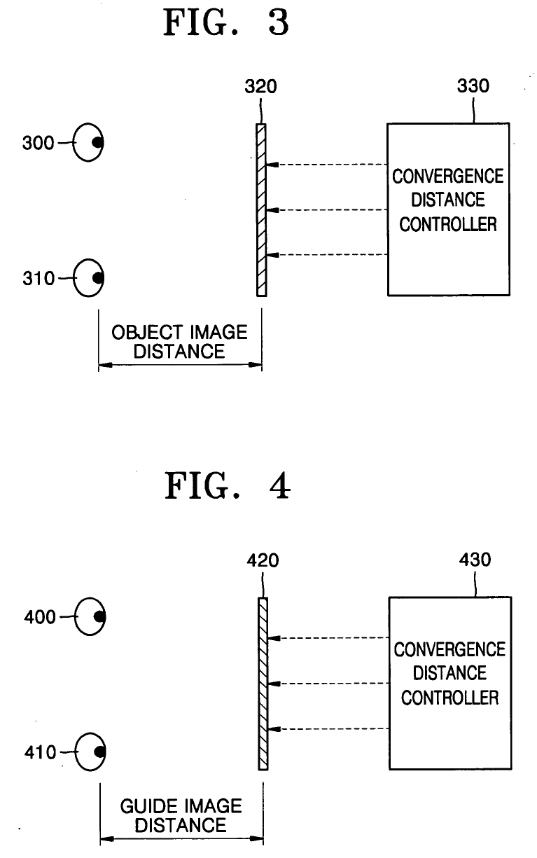

FIG. 3 is a view illustrating an object image distance.

Referring to FIG. 3, an object image 320, which is a virtual image realized by a convergence distance controller 330, means an image intended for being shown to an observer. For the object image, there exist a 3-D movie and a virtual reality.

The object image 320 is recognized as being shown by both eyeballs 300 and 310 of an observer at a position distant away a predetermined distance from the convergence distance controller 330.

Here, a distance between both eyeballs 300 and 310 of an observer and an object image point, which is a point at which the object image 320 is displayed in a virtual reality space, is called an object image distance. A point at which a virtual space where the object image is realized is positioned, is called an object image point.

FIG. 4 is a view illustrating a guide image distance.

Referring to FIG. 4, a guide image 420, which is a virtual image realized by a convergence distance controller 430, means an image shown for guiding an observer to see the object image 320 3-dimensionally. For example, a 3-D ball image or a cartoon character image which helps an observer to see an object more easily may be used as the guide image.

The guide image 420 is recognized as being shown to both eyeballs 400 and 410 of the observer at a position distant away a predetermined distance from the convergence distance controller 430.

Here, a distance between both eyeballs 400 and 410 of the observer and the guide image point at which the guide image 420 is displayed in a virtual reality space, is called a guide image distance. A point at which a virtual space where the guide image is realized is positioned, is called a guide image point.

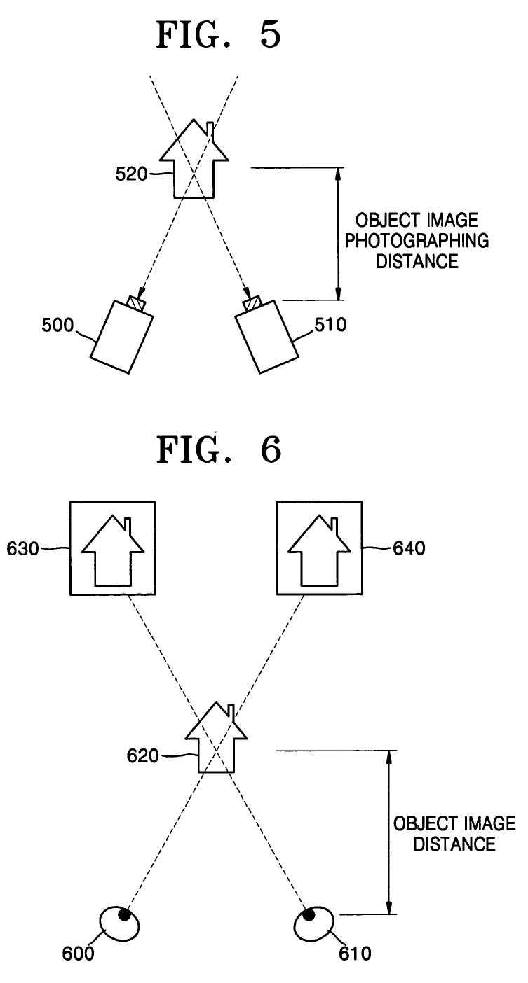

FIG. 5 is a view illustrating that object image data is obtained by photographing an object using two cameras.

Referring to FIG. 5, an object 520 should be photographed in the same way as seen by both eyeballs of the observer using two cameras 500 and 510 first to enable an observer to experience a cubic effect of an object 520 displayed as a plane image on a 2-dimensional plane. At this point, two cameras may be arranged in parallel with each other or arranged so as to converge to one point with respect to the object 520 in a 3-D space depending on a kind of camera apparatus. Here, the one converging point is called an object image point.

As described above, it is possible to provide a cubic effect to an observer by having data obtained by photographing the object 520 seen by each eyeball of the observer. An observer of a 3-D image recognizes that an object image, which is a virtual image, is displayed on a convergence point at which convergence lines of the two cameras 500 and 510 meet each other upon photographing, i.e., on a position spaced as much as an object image photographing distance, which is a distance between the object image point and the two cameras 500 and 510. In relation to this, description will be made with reference to FIG. 6.

FIG. 6 is a view illustrating that the object image data obtained in FIG. 5 is played and shown to an observer.

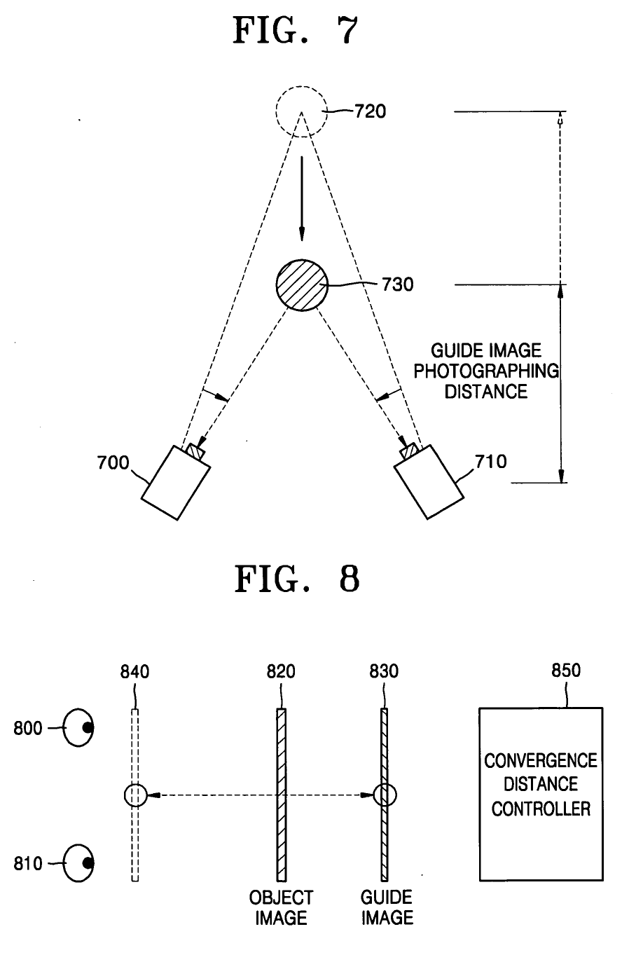

Referring to FIG. 6, an observer should maintain a convergence distance at the object image distance in order to play the object image data obtained in FIG. 5 and to see 3-dimensionally the object image 620 displayed in a virtual space distant away as much as the object image photographing distance of FIG. 5 from both eyeballs 600 and 610. Here, the object image distance means a distance spaced as much as the object image photographing distance from the observer. It is not easy for an observer to have a convergence distance coincide with the object image distance in order to see 3-dimensionally the object image formed on a position spaced as much as the object image distance. Due to the above reason, an observer cannot experience a cubic effect but rather feels dizziness even when he sees the object image 620. Thus, a method for guiding a convergence distance of an observer to an object image distance is required. In relation to this, description will be made with reference to FIGS. 7 and 8.

FIG. 7 is a view illustrating that guide image data is obtained by photographing a guide object using two cameras.

Referring to FIG. 7, guide objects 720 and 730 should be photographed in the same way as seen by both eyeballs of the observer using two cameras 700 and 710 first to enable an observer to experience a cubic effect of the objects 720 and 730 displayed as 2-dimensional plane images. At this point, two cameras may be arranged in parallel with each other or arranged so as to converge to one point on which the guide objects are positioned, respectively, for the guide objects 720 and 730 in a 3-D space depending on a kind of camera apparatus. Here, the one converging point is called a guide object point.

As described above, it is possible to give a cubic effect to an observer by having data obtained by photographing the guide objects 720 and 730 seen to each eyeball of the observer.

An observer recognizes that an object image, which is a virtual image, is displayed on a convergence point at which convergence lines of the two cameras 700 and 710 meet each other upon photographing, i.e., on a position spaced as much as a guide image photographing distance, which is a distance between the guide object point and the two cameras 700 and 710.

Here, the guide objects 720 and 730 move in a direction from the convergence distance controller to the observer by way of the object image point on which the object is positioned in FIG. 6, or moves in the direction from the observer to the convergence distance controller. The two cameras 700 and 710 pick up an image of the guide object sequentially moving in this manner. The guide image data obtained by photographing the guide object sequentially moving comes to have different guide image photographing distances, respectively, depending on a position of the guide object.

FIG. 8 is a view illustrating that the guide image data obtained in FIG. 7 is played and shown to an observer.

Referring to FIG. 8, an observer should maintain a convergence distance at the object image distance in order to play the object image data obtained in FIG. 5 and to see 3-dimensionally the object image 820 displayed in a virtual space distant away as much as the object image distance from both eyeballs 800 and 810. Since the object image distance is formed in a virtual space distant away a predetermined distance from an observer, it is not easy for the observer to have a convergence distance coincide with the object image distance.

Thus, as described with reference to FIG. 6, the observer cannot experience a cubic effect but rather feels dizziness even when the observer sees the object image 820. To solve such a problem, a method for guiding a convergence distance of an observer to an object image distance is required.

An observer recognizes guide images 830 and 840 played from the guide image data obtained in FIG. 7 and displayed 3-dimensionally in a virtual space distant away as much as the guide image photographing distance from both eyeballs 800 and 810. Here, a distance from both eyeballs 800 and 810 to the guide image displayed 3-dimensionally in a virtual space distant away as much as the guide image photographing distance, is called a guide image distance. Since such guide images 830 and 840 have a great cubic effect compared to the object image, an observer can easily recognize the 3-D image.

In addition, as described with reference to FIG. 7, the guide image data is data obtained by photographing the guide object while moving the guide object back and forth. If the guide image data is played by the convergence distance controller 850, an observer for observing the guide image displayed in a virtual space recognizes that the guide image is moved back and forth of the object image. The convergence distance controller 850 controls the guide image to sequentially move from the convergence distance controller direction (direction to which a reference numeral 830 is positioned in FIG. 8) to the observer direction (direction to which a reference numeral 840 is positioned in FIG. 8), or to sequentially move from the observer direction to the convergence distance controller direction.

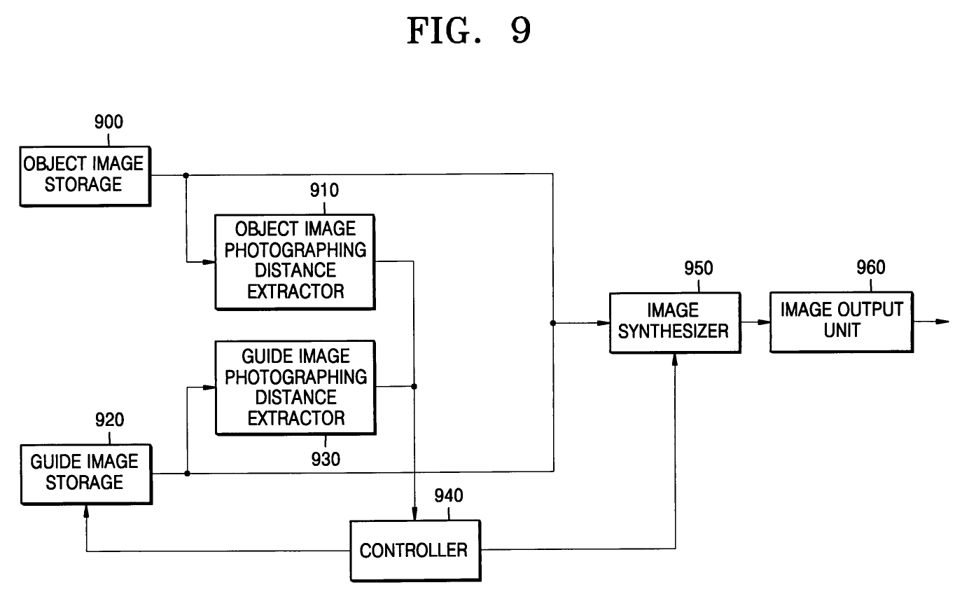

FIG. 9 is a block diagram of a convergence distance controller for observation of a 3-D image according to one embodiment of the present invention.

Referring to FIG. 9, the convergence distance controller for observation of a 3-D image includes an object image storage 900, an object image photographing distance extractor 910, a guide image storage 920, a guide image photographing distance extractor 930, an image synthesizer 950, an image output unit 960, and a controller 940.

Referring to FIG. 5, the object image storage 900 stores the object image data obtained by photographing in the same way as seen by both eyeballs of the observer using two cameras 500 and 510 to enable an observer to experience a cubic effect of the object 520 displayed as a 2-dimensional plane image.

As described above, it is possible to realize a cubic effect by having the object image, which is obtained as a result of playing the object image data obtained through photographing of the object 520, seen by each eyeball of an observer.

The object image photographing distance extractor 910 extracts an object image photographing distance which represents at which point of a virtual space object image data currently being outputted has been photographed among the object image data stored in the object image storage 900. Here, the extracting of the object image photographing distance is performed by searching header information of the object image data being stored in the object image storage 900.

Referring to FIG. 7, the guide image storage 920 stores the guide image data obtained by photographing in the same way as seen by both eyeballs of the observer using two cameras 700 and 710 to enable an observer to experience a cubic effect of the guide objects 720 and 730 displayed as 2-dimensional plane images.

The guide image photographing distance extractor 930 extracts a guide image photographing distance which represents at which point of a virtual space, guide image data currently being outputted has been photographed among the guide image data stored in the guide image storage 920. Here, the extracting of the guide image photographing distance is performed by searching header information of the guide image data being stored in the guide image storage 920.

The image synthesizer 950 receives the object image data and the guide image data from the object image storage 900 and the guide image storage 920, respectively, to synthesize those data and generate a synthesized image.

The image output unit 960 receives the synthesized image from the image synthesizer 950 to output the synthesized image. Here, the image output unit 960 may include a left image output unit (not shown) for having a synthesized image inputted from the image synthesizer 950 seen by a left eyeball of an observer and a right image output unit (not shown) for having a synthesized image seen by a right eyeball of an observer.

The controller 940 receives, from the object image photographing distance extractor 910, an object image photographing distance representing at which point of a virtual space the object image currently being outputted has been photographed.

The controller 940 controls the guide image data stored in the guide image storage 920 to be sequentially outputted and if the guide image data currently being outputted coincides with the object image photographing distance (distance between the object image point and the observer) received from the object image photographing distance extractor 910 and the guide image data is thus judged as being located at the object image photographing distance, controls to stop the outputting of the guide image data.

Detailed description will now be made for a control method of the controller 940 for finding a point at which the guide image data currently being outputted coincides with the object image photographing distance (distance between the object image point and the observer) received from the object image photographing distance extractor 910.

According to a first detailed control method, the controller 940 controls to sequentially output the photographed guide image data when the guide object moves from a point at which the convergence distance controller is positioned to a point at which an observer is positioned by way of an object image point.

In addition, the controller 940 controls to sequentially output the photographed guide image data when the guide object moves from the observer point to the object image point.

Further, the controller 940 controls to stop an outputting of the guide image data if a photographing distance of the guide image data coincides with the object image point.

According to a second detailed control method, the controller 940 controls to sequentially output the photographed guide image data when the guide object moves from the observer point to the convergence distance controller point. In addition, the controller 940 controls to sequentially output the photographed guide image data when the guide object moves from a point at which the convergence distance controller is positioned to the object image point. Further, if a photographing distance of the guide image data coincides with the object image point, the controller 940 controls to stop the outputting of the guide image data.

A detailed description will now be made for a method of the controller 940 for controlling to stop the outputting of the guide image data if the guide image data currently being outputted coincides with the object image photographing distance (distance between the object image point and the observer) received from the object image photographing distance extractor 910.

According to a first detailed control method, it is possible to control the guide image storage 920 not to provide the guide image data, photographed at a coincidence point at which the guide image data coincides with the object image photographing distance, to the image synthesizer 950 any more.

According to a second detailed control method, it is possible to control the guide image storage 920 to provide only the photographed guide image data to the image synthesizer 950 at the coincidence point. In case of the second method, the controller 940 outputs a coincidence signal to the image synthesizer 950. Then, the image synthesizer 950 receives, from the guide image storage 920, the guide image data photographed at the coincidence point and makes the received guide image data gradually flow and finally disappear.

In addition, to judge the guide image data as being photographed at a point at which the photographing distance of the guide image data currently being outputted coincides with the object image photographing distance, the controller 940 can receive, from a guide image photographing distance extractor 930 information regarding at which point of a virtual space, the guide image currently being outputted has been photographed and displayed.

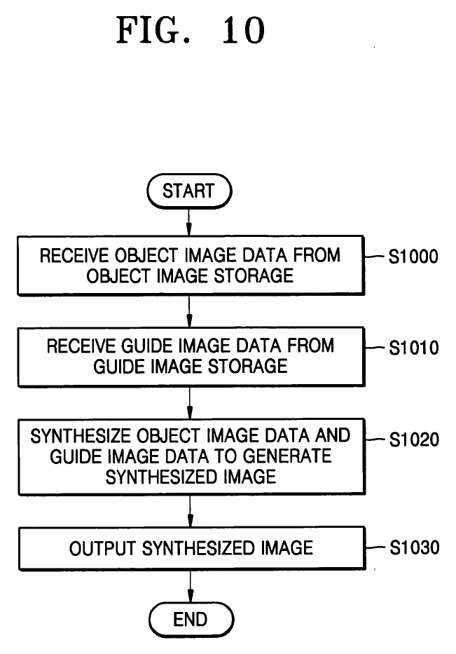

FIG. 10 is a flowchart of a method for controlling a convergence distance for observation of a 3-D image according to one embodiment of the present invention.

Referring to FIG. 10, the image synthesizer 950 of FIG. 9 receives the object image data from the object image storage 900 (S1000). Here, as described with reference to FIG. 5, the object image data means data obtained by photographing using the two cameras the object positioned spaced as much as the object photographing distance from both eyeballs of an observer.

Next, the guide image data is received from the guide image storage 920 (S1010). Here, as described with reference to FIG. 7, the guide image data means data obtained by photographing the guide object using the two cameras spaced as much as the guide object photographing distance from both eyeballs of an observer. The guide image obtained by playing, at the convergence distance controller, the guide image data is so configured as to have an observer experience a cubic effect more easily compared to the object image obtained by playing the object image data. Thus, a convergence distance of an observer is controlled through the guide image.

Next, the object image data received from the object image storage 900 and the guide image data received from the guide image storage 920 are synthesized to generate a synthesized image (S1020).

Next, the synthesized image generated at an operation S1020 is outputted so that an observer can recognize the synthesized image 3-dimensionally (S1030).

Further, the controller 940 of FIG. 9 controls the guide image data to be sequentially inputted and if the photographing distance of the guide image data coincides with the object image point, controls to stop the inputting of the guide image data. Accordingly, a convergence distance of an observer coincides with the object image point, so that the convergence distance is controlled according to one embodiment of the present invention and a cubic effect of the object image can be given to an observer.

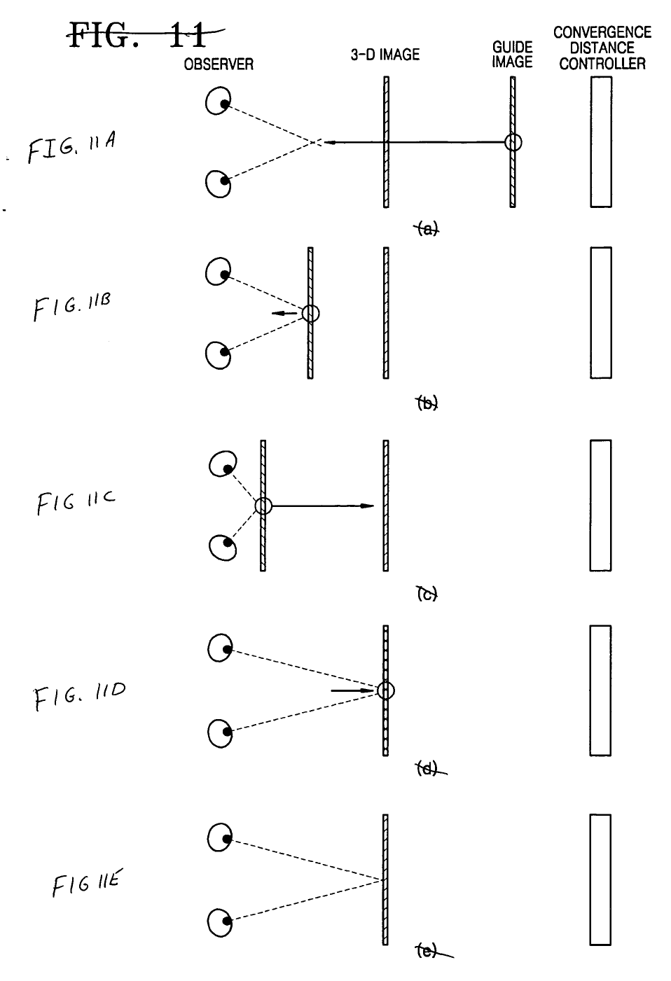

Description will be made with reference to FIGS. 11A to 11E for the control method of the controller 940 of FIG. 9, for finding a point at which the photographing distance of the guide image data coincides with the object image point while controlling the guide image data to be sequentially inputted.

FIGS. 11A to 11E are views illustrating detailed operations of a method for controlling a convergence distance for observation of a 3-D image according to one embodiment of the present invention.

Referring to FIGS. 11A to 11E, the convergence distance controller controls to output the object image at a position of a virtual space distant away as much as a predetermined distance from both eyeballs of an observer in FIG. 11A. Here, the predetermined distance means the object image distance. A point where the object image is displayed at the object image distance is called the object image point.

In addition, the convergence distance controller outputs the guide image, spaced a predetermined distance from both eyeballs of an observer.

Referring to FIG. 11A, the convergence distance controller controls to sequentially play the guide image data, starting from the guide image data photographed at a position closest to the convergence distance controller, i.e., a position most distant from the camera upon photographing of the guide object and output the guide image. The reason why the guide image data is played and the guide image is outputted starting from the guide image data photographed at a position closest to the convergence distance controller, is because where the convergence distance of an observer is located is not known. In FIG. 11A, the convergence distance is formed at an arbitrary point between both eyeballs of an observer and a position at which the object image is outputted. The convergence distance controller sequentially plays the guide image data, starting from the guide image data photographed at a position closest to the convergence distance controller, i.e., a position most distant from the camera upon photographing of the guide object, to a position at which the convergence distance of an observer is formed and outputs the guide image.

Referring to FIG. 11B, the convergence distance controller plays the guide image data generated by photographing the guide object at a position where the convergence distance of an observer is currently formed and outputs the guide image. The observer can recognize a cubic effect of the guide image in FIG. 11B.

Referring to FIG. 11C, the convergence distance controller sequentially plays the guide image data up to the guide image data photographed at a position closest to the observer's position currently, i.e., a position closest to the camera upon photographing of the guide object and outputs the guide image. The reason why the guide image is outputted by playing the guide image data up to the guide image data photographed at the position closest to the observer's position currently, i.e., the position closest to the camera upon photographing of the guide object and the guide image is outputted in this manner, is because where the convergence distance of the observer is formed is not known as described above. That is, using the fact that the convergence point of the observer exists at an arbitrary position between the position closest to the convergence distance controller and the position closest to the observer's position, the guide image data stored in the guide image storage is sequentially played and outputted. The observer who has recognized a cubic effect in FIG. 11B can experience a cubic effect of the guide image by following the guide images sequentially outputted in FIG. 11C.

Referring to FIG. 11D, the convergence distance controller sequentially plays and outputs in a reverse order, the guide image data, starting from the guide image data photographed at the position closest to the camera up to the guide image data photographed at the object image point. Information regarding the object image point can be known through an object image photographing distance received from the object image photographing distance extractor. The convergence distance controller controls to stop the sequentially outputting of the guide image data if the object image point coincides with the photographing distance of the guide image data. In that case, the object image is superposed on the guide image. Subsequent to FIG. 11C, the observer recognizes a cubic effect of the guide image by following the guide image sequentially played in a reverse order. After that, as illustrated in FIG. 11D, if the observer's convergence distance reaches the object image distance, i.e., the point at which the object image point coincides with the guide image point, the observer can experience a cubic effect of the object image as well as the cubic effect of the guide image.

Referring to FIG. 11E, the convergence distance controller controls to stop the playing of the guide image data so that the observer may recognize only a cubic effect of the object image, which is a desired image and can experience a cubic effect of the object images outputted through the convergence controller since then.

Here, it is also possible to control to have the guide image data gradually flow and finally disappear when the photographing distance of the guide image data coincides with the object image point.

Further, a method for controlling in a reverse order of FIGS. 11A through 11E will be described below.

In correspondence with FIG. 11A, the convergence distance controller sequentially plays and outputs the guide image data, starting from the guide image data photographed at a position most distant from the convergence distance controller, i.e., a position closest to the camera upon photographing of the guide object.

In correspondence with FIG. 11B, the convergence distance controller controls to play and output the guide image data photographed and generated at a position where the observer's convergence distance is currently formed.

In correspondence with FIG. 11C, the convergence distance controller controls to sequentially play and output the guide image data up to the guide image data photographed at a position most distant from the current observer's position, i.e., a position most distant from the camera upon photographing of the guide object. At this point, the observer can experience a cubic effect by observing the guide image.

In correspondence with FIG. 11D, the convergence distance controller controls to sequentially play and output in a reverse order the guide image data, starting from the guide image data photographed at a position most distant from the camera up to the guide image data photographed at the object image point. The observer can experience a cubic effect by continuously observing the guide images.

In correspondence with FIG. 11E, the convergence distance controller controls to stop the playing of the guide image data so that the observer may recognize a cubic effect of only the object image, which is a desired image, and can experience a cubic effect of the object images outputted through the convergence controller since then.

In relation to one embodiment of the present invention, description has been made in view of controlling the convergence distance so that the observer can experience a cubic effect of the object image. Further, the convergence distance controller may show the guide image while the observer sees the object image so as to induce the observer to move his eyeballs. That is, while seeing the object image, the observer can perform an eyeball movement by seeing the guide image from the convergence distance controller, that is felt to be moving back and forth. Thus, the observer can reduce eyesight fatigue generated while seeing the object image.

The present invention is directed to the method and the apparatus for controlling the convergence distance for observation of the 3-D image, in which the observer can easily find the convergence distance at which the observer can experience a cubic effect of the object image such as a 3-D movie or a virtual reality using the guide image.

In addition, the observer may control the convergence distance by following the guide image provided from the convergence distance controller, thus the separate head/eyeball movement detector for detecting a head/eyeball movement in order to ascertain the convergence distance of the observer needs not to be provided. Further, an inconvenience of wearing a separate display apparatus is removed.

Still further, according to the present invention, it is possible to induce the observer to perform an eyeball movement by providing the guide image while the observer sees the object image for a long time, and thus to reduce a eyesight fatigue.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A convergence distance controller comprising:
an object image storage configured to store object image data, which is data representing an object image for viewing by an observer and generated by photographing 3-dimensionally an object positioned at an object image point, which is a predetermined point in a space;
a guide image storage configured to store guide image data, which is data for guiding a convergence distance of the observer and generated by photographing a guide object 3-dimensionally while sequentially moving the guide object back and forth with respect to the object image point;
an image synthesizer configured to receive the object image data and the guide image data to generate a synthesized image; and
a controller configured to sequentially output the guide image data stored in the guide image storage and if a photographing distance of the guide image data coincides with an object image point, to stop the outputting of the guide image data to control a convergence distance of the observer to coincide with the object image point.

2. The convergence distance controller of claim 1, wherein the photographing of the object is performed by two cameras; one camera photographs the object at a position that corresponds to a left eyeball of the observer and the other camera photographs the object at a position that corresponds to a right eyeball of the observer.

3. The convergence distance controller of claim 1, wherein a recognition rate of a cubic effect by the guide image data is greater than that of a cubic effect by the object image data.

4. The convergence distance controller of claim 1, wherein the guide image data is obtained by using a camera to photograph the guide object moving in a direction from the convergence distance controller to an observer, or moving in a direction from the observer to the convergence distance controller by way of the object image point.

5. The convergence distance controller of claim 1, further comprising:
an object image photographing distance extractor configured to receive the object image data from the object image storage to extract an object image photographing point; and
a guide image photographing distance extractor configured to receive the guide image data outputted to the image synthesizer from the guide image storage to extract a guide image photographing distance.

6. The convergence distance controller of claim 5, wherein the controller receives and compares the object image photographing distance and the guide image photographing distance and controls the guide image data outputted to the image synthesizer from the guide image storage such that the guide image photographing distance coincides with the object image photographing distance.

7. The convergence distance controller of claim 1, wherein the controller controls to sequentially output photographed guide image data while the guide object moves from a point at which the convergence distance controller is positioned to a point at which the observer is positioned by way of the object image point and to sequentially output photographed guide image data while the guide object moves from the observer point to the object image point and if a photographing distance of the guide image data coincides with the object image point, controls to stop the outputting of the guide image data.

8. The convergence distance controller of claim 1, wherein the controller controls to sequentially output photographed guide image data while the guide object moves from a point at which the observer is positioned to a point at which the convergence distance controller is positioned and to sequentially output photographed guide image data while the guide object moves from a point at which the convergence distance controller is positioned to an object image point, and if a photographing distance of the guide image data coincides with the object image point, controls to stop the outputting of the guide image data.

9. The convergence distance controller of claim 1, wherein the controller outputs a position coincidence signal to the image synthesizer if a photographing distance of the guide image data coincides with the object image point and the image synthesizer has a guide image generated by playing of the guide image data gradually disappear from the synthesized image.

10. The convergence distance controller of claim 1, further comprising an image output unit for outputting the synthesized image outputted from the image synthesizer.

11. The convergence distance controller of claim 10, wherein the image output unit comprises:
a left image output unit for contributing to the synthesized image a perspective of a left eyeball of the observer; and
a right image output unit for contributing to the synthesized image a perspective of a right eyeball of the observer.

12. A method for controlling a convergence distance in an apparatus for controlling a convergence distance, comprising:
receiving object image data, which is data representing an object image for viewing by an observer and generated by photographing 3-dimensionally an object positioned at an object image point, which is a predetermined point in a space;
receiving guide image data, which is data for guiding a convergence distance of the observer and generated by photographing a guide object 3-dimensionally while sequentially moving the guide object back and forth with respect to the object image point;
receiving the object image data and the guide image data to synthesize the object image data and the guide image data and output a synthesized image; and
controlling the guide image data to be sequentially received and if a photographing distance of the guide image data coincides with an object image point, controlling to stop the receiving of the guide image data so that a convergence distance of an observer coincides with the object image point.

13. The method of claim 12, wherein the guide image data is obtained by using a camera to photograph the guide object moving from a point at which the convergence distance controller is positioned to a point at which the observer is positioned by way of the object image point, or moving from the point at which the observer is positioned to the point at which the convergence distance controller is positioned by way of the object image point.

14. The method of claim 13, wherein the controlling of the guide image data comprises:
controlling to sequentially output photographed guide image data while the guide object moves from the point at which the convergence distance controller is positioned to the point at the observer is positioned by way of the object image point;
controlling to sequentially output photographed guide image data while the guide object moves from the point at which the observer is positioned to the object image point; and
if a photographing distance of the guide image data coincides with the object image point, controlling to stop the outputting of the guide image data.

15. The method of claim 13, wherein the controlling of the guide image data comprises:
controlling to sequentially output photographed guide image data while the guide object moves from the point at which the observer is positioned to the point at which the convergence distance controller is positioned;
controlling to sequentially output photographed guide image data while the guide object moves from the point at which the convergence distance controller is positioned to the object image point; and
if a photographing distance of the guide image data coincides with the object image point, controlling to stop the outputting of the guide image data.

16. The method of claim 12, wherein the controlling to stop the receiving of the guide image data comprises:
controlling the receiving of the guide image data to gradually disappear if the photographing distance of the guide image data coincides with the object image point.

17. The method of claim 12, wherein a recognition rate of a cubic effect by the guide image data is greater than that of a cubic effect by the object image data.

18. A computer-readable recording medium storing a program for executing the method claimed in claim 12 on a computer.
